(19) United States
(12) Patent Application Publication
(10) Pub. No.: US 2014/0188406 A1
(43) Pub. Date: Jul. 3, 2014

(54) SCALABLE VEHICLE MODELS FOR INDOOR TIRE TESTING

(71) Applicant: Bridgestone Americas Tire Operations, LLC, Nashville, TN (US)

(72) Inventors: David O. Stalnaker, Hartville, OH (US); Ke Jun Xie, Copley, OH (US); Erik F. Knuth, Hudson, OH (US); John L. Turner, Tucson, AZ (US); Paul M. Neugebauer, Akron, OH (US)

(73) Assignee: Bridgestone Americas Tire Operations, LLC, Nashville, TN (US)

(21) Appl. No.: 14/043,948

(22) Filed: Oct. 2, 2013

Related U.S. Application Data
(60) Provisional application No. 61/746,913, filed on Dec. 28, 2012.

(51) Int. Cl. G01M 17/02; G06F 17/50

(52) U.S. Cl. CPC G01M 17/02; G06F 17/5095
USPC 702/34; 703/2

(57) ABSTRACT

Tire testing systems and methods are disclosed for indoor simulation testing of tires of a wide range of sizes on a scalable vehicle model (“SVM”).

### CROSS-REFERENCE TO RELATED APPLICATIONS

This application claims priority from U.S. Provisional Patent Application No. 61/746,913, filed on Dec. 28, 2012, which is incorporated by reference herein in its entirety.

### BACKGROUND

Tire manufacturers often perform wear testing on tires. Tire tread wear may be influenced by a number of variables other than the tire construction and tread compound, such as: environmental factors (such as temperature and rain fall), driver severity (such as driving style and route composition), pavement characteristics, and tire and vehicle dynamic properties (such as weight, location of center of gravity, load transfer during maneuvers, steering kinematics, and the like). In order to accurately measure tire tread wear and make comparisons between various tire models, testing must be conducted in such a manner as to hold constant the influences from the environment, driver severity, pavement, and vehicle so as to not bias the tread wear results. Vehicle characteristics can have a significant effect on a tire's wear rate and cause an irregular wear propensity. As long as all tires in the test are evaluated on the same vehicle model, the bias introduced by the vehicle will be the same for all test tire models.

Some tires, such as original equipment manufacturer (“OEM”) tires, are developed specifically for a particular vehicle. In this case, tire testing should be done on the specific OEM vehicle, or, if tested on an indoor test machine, the vehicle should be precisely simulated. However, many tires are designed as a replacement to worn or damaged OEM tires; these tires are referred to as “trade tires.” Trade tires may not be developed specifically for one particular vehicle, but rather, for an entire market segment of vehicles comprising a large variety of tire sizes and respective load capacities. A variety of sizes and different tire load requirements will normally require testing on different vehicles, which may have and different ballast conditions. When this is the case, the vehicle-to-vehicle bias and the test tires' wear performances are inseparable. For indoor testing, it is desirable to create a vehicle model that is “typical” of the vehicles in a certain segment (for example, front wheel drive sedans or pick-up trucks), and which is continuously scalable to different loads.

Tire testing systems and methods are needed to permit indoor simulation testing of tires of a wide range of sizes on a scalable vehicle model (“SVM”), which permits measurement of tire performance without vehicle-to-vehicle bias.

### SUMMARY

In one embodiment, a method for creating a scalable vehicle model (SVM) for indoor tire testing is provided, the method comprising: selecting a vehicle segment representing a plurality of individual vehicles having various weights; defining at least one vehicle model parameter, including at least one of: the vehicle's wheel base, the vehicle's wheel track, the vehicle's center of gravity, the vehicle's suspension compliance, the vehicle's suspension kinematics, the vehicle's suspension alignment, the vehicle's steering kinematics, the vehicle's weight distribution, the vehicle's ballasting, the vehicle's front-to-rear brake proportioning, tire stiffness, the vehicle's aerodynamic drag, the vehicle's frontal area, the vehicle's auxiliary roll stiffness, the vehicle's fore-aft stiffness, the vehicle's cornering stiffness, and the vehicle's unsprung mass; the and characterizing the at least one vehicle model parameter through regression analysis as a function of the total weight of a SVM (“W”), using the equation P(W)=C₀(W)+C₁(W)A+C₂(W)A²+C₃(W)A³, wherein P(W) is the at least one vehicle model parameter, wherein Cₙ(W) is a regression coefficient as a polynomial function of W, and wherein A is an independent variable, including at least one of: jounce and steering angle. In one embodiment, Cₙ(W) is equal to aₙ₀+aₙ₁W+aₙ₂W²+aₙ₃W³. In another embodiment, the method may further comprise creating a SVM as a function of W. In another embodiment, the method may further comprise implementing the characterization of at least one vehicle model parameter as a function of W to a vehicle dynamics software and applying the SVM to at least one maneuver using the vehicle dynamics software to determine tire load history of at least one tire of the SVM.

In another embodiment, a method for creating a scalable vehicle model (SVM) for indoor tire testing is provided, the method comprising: selecting a vehicle segment representing a plurality of individual vehicles having various weights; defining at least one vehicle model parameter, including at least one of: the vehicle's wheel base, the vehicle's wheel track, the vehicle's center of gravity, the vehicle's suspension compliance, the vehicle's suspension kinematics, the vehicle's suspension alignment, the vehicle's steering kinematics, the vehicle's weight distribution, the vehicle's ballasting, the vehicle's front-to-rear brake proportioning, tire stiffness, the vehicle's aerodynamic drag, the vehicle's frontal area, the vehicle's auxiliary roll stiffness, the vehicle's fore-aft stiffness, the vehicle's cornering stiffness, and the vehicle's unsprung mass characterizing the at least one vehicle model parameter through regression analysis as a function of the total weight of a SVM (“W”), using the equation P(W)=C₀(W)+C₁(W)A+C₂(W)A²+C₃(W)A³, wherein P(W) is the at least one vehicle model parameter, wherein Cₙ(W) is a regression coefficient as a function of W, and is equal to aₙ₀+aₙ₁W+aₙ₂W²+aₙ₃W³, wherein A is an independent variable, including at least one of: jounce and steering angle; and using vehicle dynamics software to input the characterization of the at least one vehicle model parameter as a function of W.

In another embodiment, a method for creating a scalable vehicle model (SVM) for indoor tire testing is provided, the method comprising: selecting a vehicle segment representing a plurality of individual vehicles having various weights; defining at least one vehicle model parameter, including at least one of: the vehicle's wheel base, the vehicle's wheel track, the vehicle's center of gravity, the vehicle's suspension compliance, the vehicle's suspension kinematics, the vehicle's suspension alignment, the vehicle's steering kinematics, the vehicle's weight distribution, the vehicle's ballasting, the vehicle's front-to-rear brake proportioning, tire stiffness, the vehicle's aerodynamic drag, the vehicle's frontal area, the vehicle's auxiliary roll stiffness, the vehicle's fore-aft stiffness, the vehicle's cornering stiffness, and the vehicle's unsprung mass, characterizing the at least one vehicle model parameter through regression analysis as a function of the total weight of a SVM (“W”), using the equation P(W)=C₀(W)+C₁(W)A+C₂(W)A²+C₃(W)A³, wherein P(W) is the at least one vehicle model parameter, wherein Cₙ(W) is a regression coefficient as a function of W, and is equal to aₙ₀+aₙ₁W+aₙ₂W²+aₙ₃W³, wherein A is an independent variable, including at least one of: jounce and steering angle; using vehicle dynamics software to input the characterization of the at least one vehicle model parameter as a function of W; applying the SVM to at least one maneuver in the vehicle dynamics software to determine at least one of: acceleration, deceleration, and lateral acceleration; and creating a wheel loading history for each wheel of the SVM; and creating the SVM scalable as a function of W.

### BRIEF DESCRIPTION OF THE DRAWINGS

The accompanying figures, which are incorporated in and constitute a part of the specification, illustrate various example methods, data sets, and results and are used merely to illustrate various example embodiments. In the figures, like elements bear like reference numerals.

FIG. 1 illustrates example results following P(W) regression analysis of a data set.

FIG. 2 illustrates example results following P(W) regression analysis of a data set.

FIG. 3 illustrates example results following P(W) regression analysis of a data set.

FIG. 4 illustrates an example method 400 for creating a SVM for indoor tire testing.

FIG. 5 illustrates an example method 500 for creating a SVM for indoor tire testing.

FIG. 6 illustrates an example method 600 for creating a SVM for indoor tire testing.

### DETAILED DESCRIPTION

A trade tire may be configured to fit a segment of vehicles, having a range of weights, rim sizes, suspension geometry, steering geometry, and the like. The trade tire may be optimized to provide the best wear characteristics for the segment of vehicles.

Testing of the trade tire on an actual vehicle causes vehicle bias to affect the test results. That is, if the tire is tested on vehicle A, vehicle A's weight, rim size, suspension geometry, steering geometry, and the like may affect the tire's wear performance differently from vehicle B.

A SVM in each vehicle segment, which reflects the general characteristics of the vehicle segment while being gradually and continuously scalable may be used in place of any of various vehicles in a vehicle segment. Substitution of a SVM for vehicle A, vehicle B, and the like acts to remove vehicle bias from trade tire indoor testing and eliminates a need for actual testing of the trade tire on each individual vehicle A, vehicle B, and the like.

Various vehicle segments may be used. Possible vehicle segments may include, for example, rear-wheel drive (“RWD”) pickup trucks, front-wheel drive (“FWD”) sedans, and large sport utility vehicles (“SUVs”). UTQG test requirements may vary across vehicle segments. For example, RWD pickup trucks may require 50/50 front to rear ballasting. As another example, FWD sedans may require curb plus driver ballasting. In one embodiment, any of various vehicle segments may be created and analyzed. In another embodiment, vehicle segments may be created based upon the intended vehicles upon which any of a variety of trade tires may be applied. In one embodiment, the various vehicles of a vehicle segment may have various weights.

Following the definition or selection of a particular vehicle segment representing a plurality of vehicles having various weights, one may define at least one vehicle model parameter, including at least one of: the vehicle's wheel base, the vehicle's wheel track, the vehicle's center of gravity, the vehicle's suspension compliance, the vehicle's suspension kinematics, the vehicle's suspension alignment, the vehicle's steering kinematics, the vehicle's weight distribution, the vehicle's ballasting, the vehicle's front-to-rear brake proportioning, tire stiffness, the vehicle's aerodynamic drag, the vehicle's frontal area, the vehicle's auxiliary roll stiffness, the vehicle's fore-aft stiffness, the vehicle's cornering stiffness, and the vehicle's unsprung mass. In one embodiment, at least the following vehicle model parameters are defined: the vehicle's wheel base, the vehicle's wheel track, the vehicle's center of gravity, the vehicle's suspension stiffness, the vehicle's suspension kinematics, the vehicle's static alignment, the vehicle's steering kinematics, the vehicle's front-to-rear weight distribution, the vehicle's front-to-rear brake split, the stiffness of a tire on the vehicle, the vehicle's aerodynamic drag, the vehicle's auxiliary roll stiffness, and the vehicle's unsprung mass.

In one embodiment, various of the at least one vehicle model parameters are fixed between vehicles when developing the SVM. These model parameters may include: vehicle weight distribution, front-to-rear brake split, and suspension static alignment.

In one embodiment, various of the at least one vehicle model parameters are scalable between vehicles when developing the SVM. The model parameters may include: wheel base, wheel track, center of gravity, aerodynamic drag, suspension stiffness, roll stiffness, suspension kinematics, and tire stiffness.

In one embodiment, each vehicle of the selected vehicle segment is analyzed with respect to at least one vehicle model parameter relative to the vehicle's total vehicle weight.

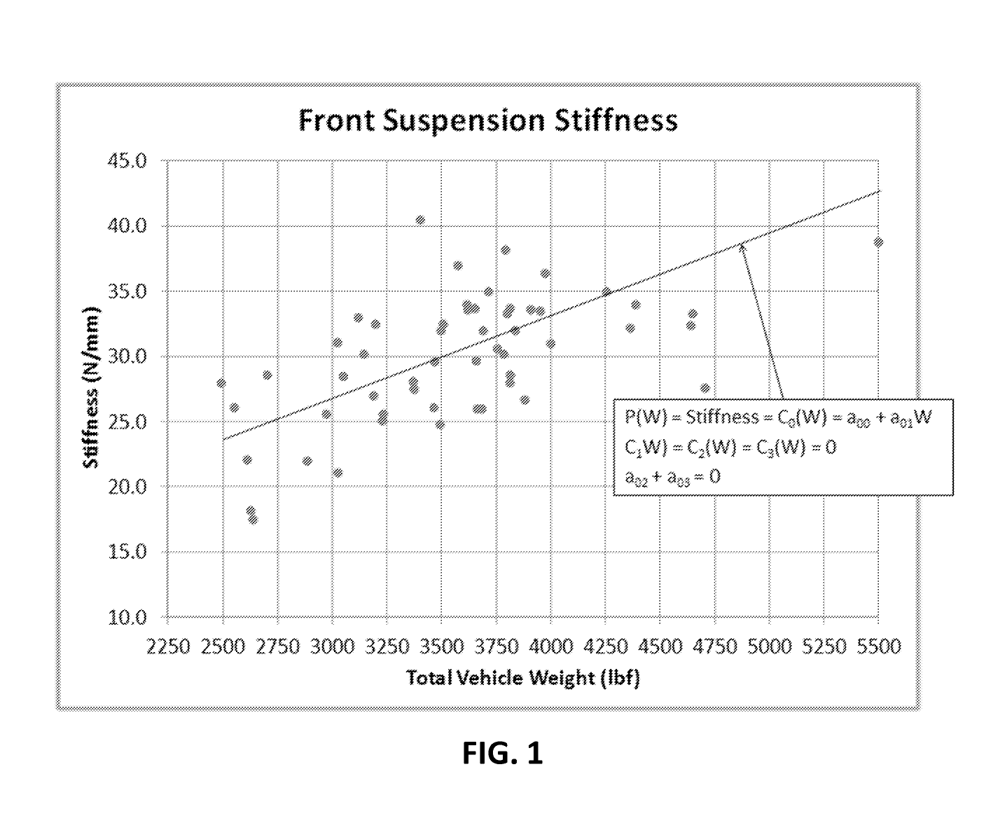

FIG. 1 illustrates example results following regression analysis of a data set. The data set illustrates front suspension stiffness versus total vehicle weight. Each point indicated in the example data set represents a vehicle of the vehicle segment, and its total vehicle weight. For example, FIG. 1 indicates a vehicle comprising a total vehicle weight of approximately 2,500 lbf, with a front suspension stiffness of approximately 28.0 N/mm. In another example, FIG. 1 indicates a vehicle comprising a total vehicle weight of approximately 4,250 lbf, with a front suspension stiffness of approximately 35.0 N/mm. The suspension stiffness of a vehicle may play a role in the amount of force experienced in that vehicle's tire during operation.

The front suspension stiffness data is applied to regression analysis to create a SVM suspension stiffness illustrated as the line representing P(W). In one embodiment, the line representing P(W) is used in a SVM to estimate the suspension stiffness of the SVM at any of various weights from 2,250 lbf to 5,500 lbf.

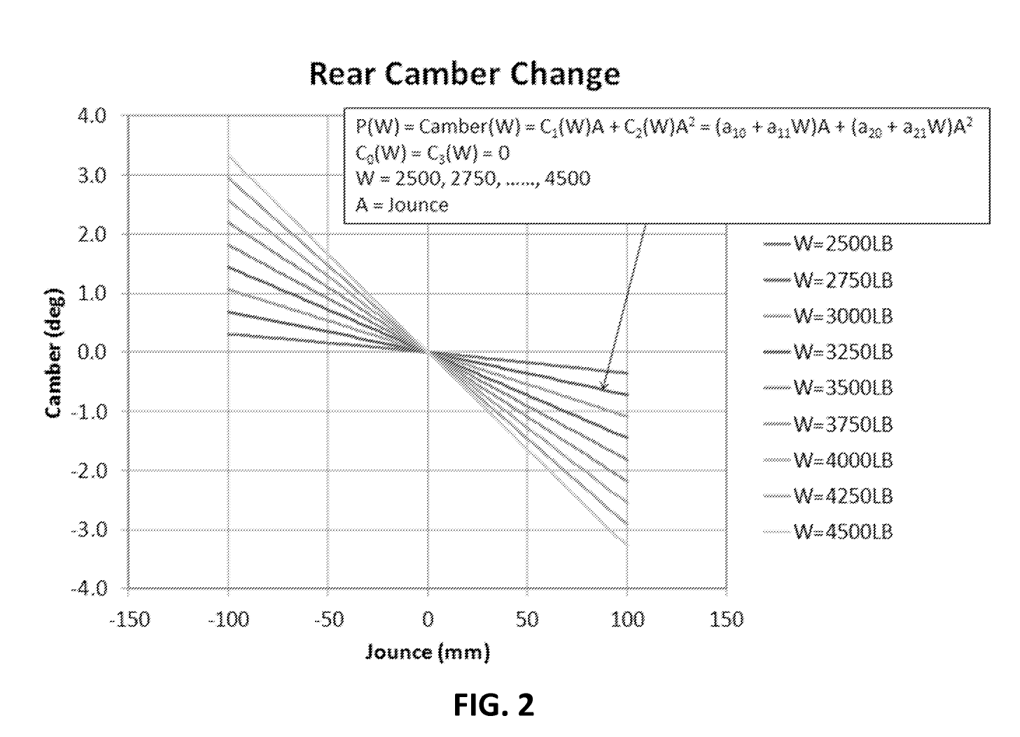

FIG. 2 illustrates example results following regression analysis of a data set. The data set illustrates rear camber change versus jounce in a variety of vehicles in a vehicle segment. Each line indicated in the example data set represents a vehicle of the vehicle segment, and the relationship of its rear camber to its jounce. Each vehicle's rear camber is approximately 0.0 degrees when that vehicle's jounce is approximately 0 mm. For example, FIG. 2 indicates that a Vehicle 6 has a rear camber of approximately −1.0 degree when it's jounce is approximately 50 mm. The rear camber of a vehicle may play a role in the inclination angle experienced in that vehicle's tire during operation.

In one embodiment, the at least one vehicle model parameter is characterized through regression analysis as a function of the total weight of the SVM (“W”). In one embodiment, the at least one vehicle model parameter is characterized through regression analysis using the equation P(W)=C₀(W)+C₁(W)A+C₂(W)A²+C₃(W)A³. P(W) may be the at least one vehicle model parameter. Cₙ(W) may be a regression coefficient as a function of W, and is equal to aₙ₀+aₙ₁W+aₙ₂W²+aₙ₃W³. A may be an independent variable, including at least one of: jounce and steering angle.

The rear camber change versus jounce data is applied to regression analysis to create a SVM rear camber change illustrated as a series of lines representing P(W). Each line representing P(W) pertains to a specific vehicle weight. In one embodiment, a line representing P(W) for a specific vehicle weight is used to estimate the relationship between rear camber change in jounce in a SVM of that weight.

In one embodiment, each of the at least one vehicle model parameter is characterized through regression analysis in the same manner as either the front suspension stiffness data illustrated in FIG. 1 or the rear camber change versus jounce data illustrated in FIG. 2.

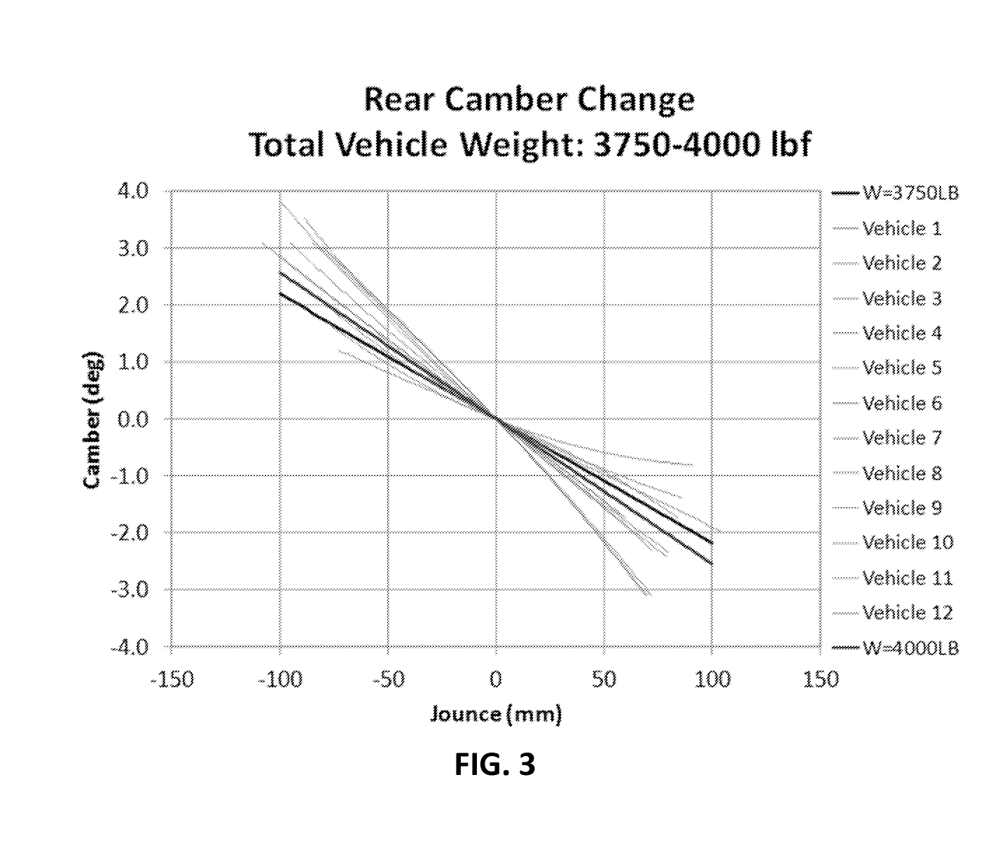

FIG. 3 illustrates example results following regression analysis of the data set illustrated in FIG. 2. FIG. 3 illustrates regression lines for SVM weighing 3,750 lbf and 4,000 lbf plotted with pre-regression analysis rear camber change versus jounce in a variety of vehicles in a vehicle segment. The regression lines represent P(W) and permit a scalable linear predictability for determining rear camber versus jounce in a SVM.

Following the characterization of at least one vehicle model parameter as a function of W, vehicle dynamics software may be used to input the characterization. In one embodiment, vehicle dynamics software is available from Mechanical Simulation Corporation of Ann Arbor, Mich., under the name “CarSim.” In another embodiment, the vehicle dynamics software is any possible vehicle dynamics software, including commercially available or proprietary vehicle dynamics software.

In one embodiment, the input of the at least one vehicle model parameter as a function of W into vehicle dynamics software may be used to develop discrete SVM with scalable vehicle attributes at a set of representative weights. In another embodiment, the input of the at least one vehicle model parameter as a function of W into vehicle dynamics software may be used to develop discrete SVM with scalable vehicle attributes at a set of representative corner loads.

In one embodiment, the SVM is represented in vehicle dynamics software, and the SVM is simulated in a suite of standard maneuvers to provide results for indoor UTQG wear modeling on a wear test drum. In another embodiment, the SVM is applied to at least one maneuver in the vehicle dynamics software to determine at least one of: acceleration, deceleration, and lateral acceleration. A tire loading history for each tire of the SVM may be created based upon the application of the SVM to at least one maneuver in the vehicle dynamics software.

Following the application of the SVM to at least one maneuver in the vehicle dynamics software, one may create at least one formula for a tire force and inclination angle per a tire position on the SVM. In one embodiment, the tire force is a function of at least one of a center of gravity acceleration and velocity of the SVM. In another embodiment, the inclination angle is a function of at least one of center of gravity acceleration and velocity of the SVM.

In one embodiment, creating at least one formula comprises regression curve fit of a tire load as a function of the SVM's acceleration. In another embodiment, creating at least one formula comprises regression curve fit of a tire load as a function of the SVM's velocity. In another embodiment, creating at least one formula comprises regression curve fit of a tire load as a function of the SVM's path curvature. In another embodiment, creating at least one formula comprises regression curve fit of a tire inclination angle as a function of the SVM's acceleration. In another embodiment, creating at least one formula comprises regression curve fit of a tire inclination angle as a function of the SVM's velocity. In another embodiment, creating at least one formula comprises regression curve fit of a tire inclination angle as a function of the SVM's path curvature.

In one embodiment, the at least one formula is used to drive an indoor tire test machine. The indoor tire test machine may test tire for at least one of durability and wear. In another embodiment, the at least one formula is used to input information into a finite element analysis.

In one embodiment, the SVM is characterized by measuring the three directional forces (Fx, Fy, and Fz) and inclination angles experienced by each of the tires during the at least one simulated maneuver. Force Fx is the fore-aft force applied to the tire at its contact patch parallel to its direction of rotation. Force Fy is the lateral force applied to the tire at its contact patch perpendicular to its direction of rotation. Force Fz is the vertical force applied to the tire at its contact patch.

In one embodiment, the SVM is characterized by measuring the accelerations (Ax and Ay) and velocity (Vx) of the vehicle when the three directional forces and inclination angles are measured. Acceleration Ax is the fore-aft acceleration of the vehicle. Acceleration Ay is the lateral acceleration of the vehicle. Velocity Vx is the fore-aft velocity of the vehicle.

In one embodiment, formulas are created that relate the vehicle accelerations Ax and Ay and velocity Vx to the three directional forces Fx, Fy, and Fz and inclination angles experienced by each of the tires. In one embodiment, the formulas are Fx=f₁(Ax, Ay, Vx); Fy=f₂(Ax, Ay, Vx); Fz=f₃(Ax, Ay, Vx); and IA=f₄(Ax, Ay, Vx).

In one embodiment, the fore-aft acceleration Ax and lateral acceleration Ay experienced by the SVM in the at least one simulated maneuver is measured. In another embodiment, the fore-aft velocity Vx of the SVM in the at least one simulated maneuver is measured.

In one embodiment, one predicts the force data and inclination angle that represents forces and inclination angles that would be experienced by the SVM if the SVM were driven through additional maneuvers, simulated or real. In one embodiment, the fore-aft acceleration Ax, lateral acceleration, Ay, and fore-aft velocity Vx of the SVM in the at least one simulated maneuver is substituted for vehicle accelerations Ax, Ay, and velocity Vx in the formulas Fx=f₁(Ax, Ay, Vx); Fy=f₂(Ax, Ay, Vx); Fz=f₃(Ax, Ay, Vx); and IA=f₄(Ax, Ay, Vx) for any chosen SVM tire.

In one embodiment, the predicted force and inclination angle data is used to drive an indoor wear test machine. Indoor wear testing of a tire may comprise application of a tire to a wear test drum. The tire may be mounted on a rim, which is affixed to a mechanism comprising an axle. The tire may be inflated to its intended operating pressure, or any desired possible pressure. The wear test drum may provide a rotating cylindrical surface configured to simulate a road surface. The tire may be contacted against the wear test drum to simulate a tire operating on a road surface. The mechanism may be configured to apply the tire against the wear test drum with specific forces and inclination angle. The application forces of the tire against the wear test drum may represent a tire's loading due to the weight of the vehicle, the cargo of the vehicle, acceleration of the vehicle, deceleration of the vehicle, velocity of the vehicle, cornering of the vehicle, and the like. The application inclination angle of the tire against the wear test drum may represent a tire's inclination angle due to jounce, weight of the vehicle, acceleration of the vehicle, deceleration of the vehicle, cornering of the vehicle, and the like.

In another embodiment, the predicted force and inclination angle data is used to drive an indoor tire test machine. The indoor tire test machine may be configured to test the tire's durability. In one embodiment, the indoor tire test machine is configured to test the tire's wear. In another embodiment, the predicted force and inclination angle data is used to input information into a finite element analysis.

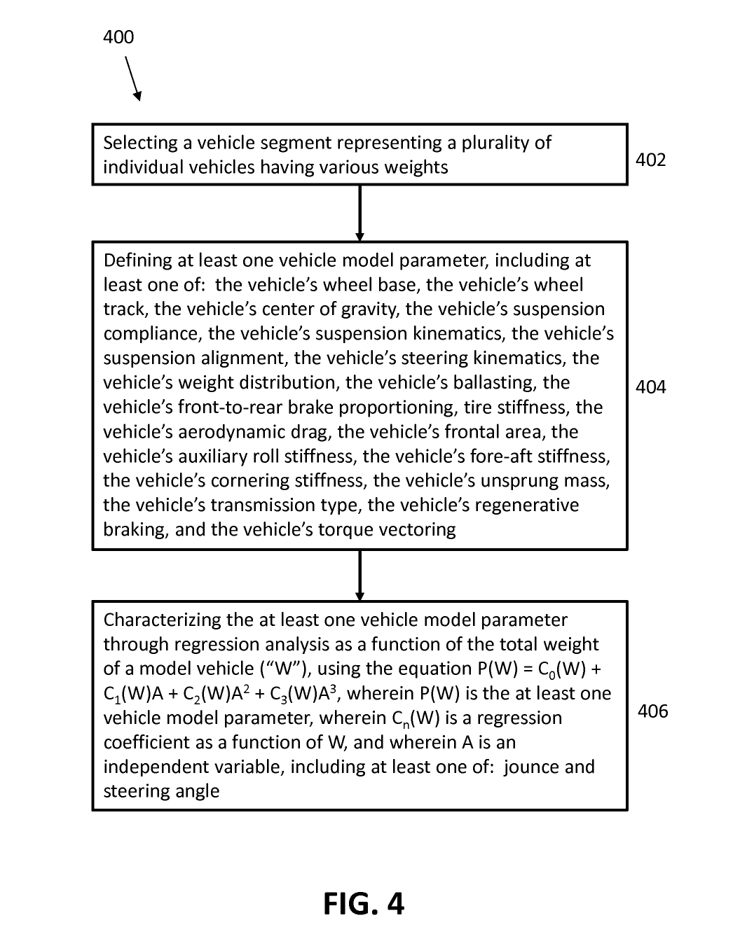

FIG. 4 illustrates an example method 400 for creating a SVM for indoor tire testing. The method comprises selecting a vehicle segment representing a plurality of individual vehicles having various weights (step 402). The method may comprise defining at least one vehicle model parameter, including at least one of: the vehicle's wheel base, the vehicle's wheel track, the vehicle's center of gravity, the vehicle's suspension compliance, the vehicle's suspension kinematics, the vehicle's suspension alignment, the vehicle's steering kinematics, the vehicle's weight distribution, the vehicle's ballasting, the vehicle's front-to-rear brake proportioning, tire stiffness, the vehicle's aerodynamic drag, the vehicle's frontal area, the vehicle's auxiliary roll stiffness, the vehicle's fore-aft stiffness, the vehicle's cornering stiffness, the vehicle's unsprung mass, the vehicle's transmission type, the vehicle's regenerative braking, and the vehicle's torque vectoring (step 404). The method may comprise characterizing the at least one vehicle model parameter through regression analysis as a function of the total weight of a SVM (“W”), using the equation P(W)=C₀(W)+C₁(W)A+C₂(W)A²+C₃(W)A³, wherein P(W) is the at least one vehicle model parameter, wherein Cₙ(W) is a regression coefficient as a function of W, and wherein A is an independent variable, including at least one of: jounce and steering angle (step 406).

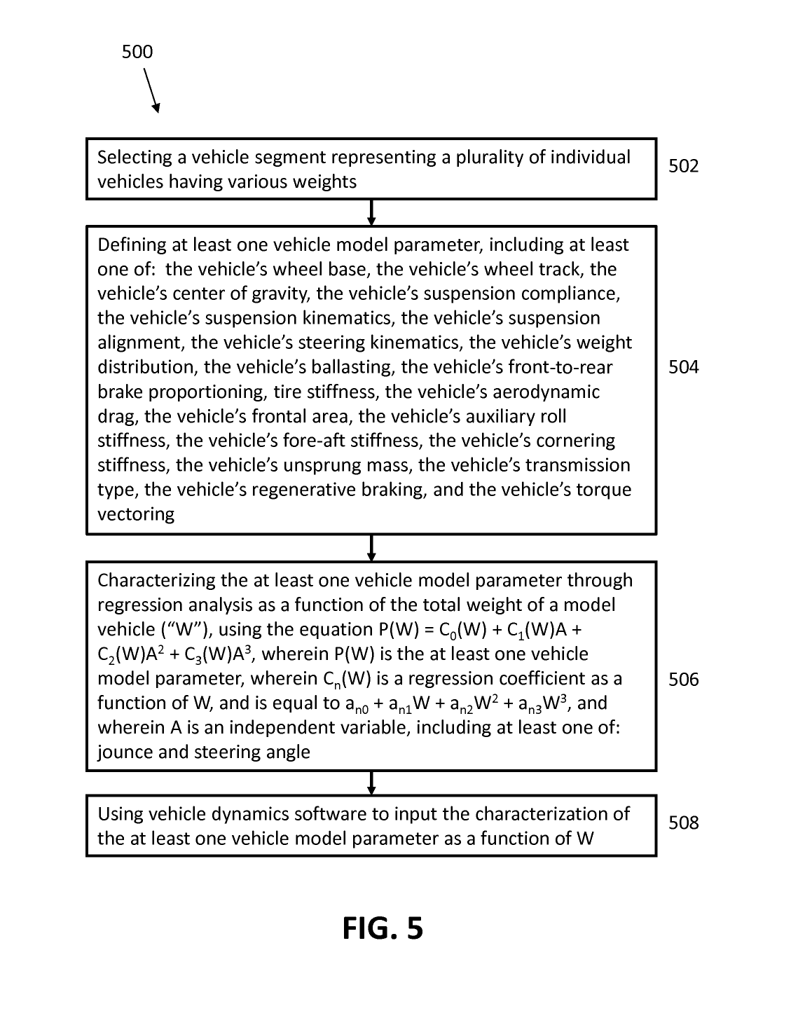

FIG. 5 illustrates an example method 500 for creating a SVM for indoor tire testing. The method comprises selecting a vehicle segment representing a plurality of individual vehicles having various weights (step 502). The method may comprise defining at least one vehicle model parameter, including at least one of: the vehicle's wheel base, the vehicle's wheel track, the vehicle's center of gravity, the vehicle's suspension compliance, the vehicle's suspension kinematics, the vehicle's suspension alignment, the vehicle's steering kinematics, the vehicle's weight distribution, the vehicle's ballasting, the vehicle's front-to-rear brake proportioning, tire stiffness, the vehicle's aerodynamic drag, the vehicle's frontal area, the vehicle's auxiliary roll stiffness, the vehicle's fore-aft stiffness, the vehicle's cornering stiffness, the vehicle's unsprung mass, the vehicle's transmission type, the vehicle's regenerative braking, and the vehicle's torque vectoring (step 504). The method may comprise characterizing the at least one vehicle model parameter through regression analysis as a function of the total weight of a SVM (“W”), using the equation P(W)=C₀(W)+C₁(W)A+C₂(W)A²+C₃(W)A³, wherein P(W) is the at least one vehicle model parameter, wherein Cₙ(W) is a regression coefficient as a function of W, and is equal to aₙ₀+aₙ₁W+aₙ₂W²+aₙ₃W³, and wherein A is an independent variable, including at least one of: jounce and steering angle (step 506). The method may comprise using vehicle dynamics software to input the characterization of the at least one vehicle model parameter as a function of W (step 508).

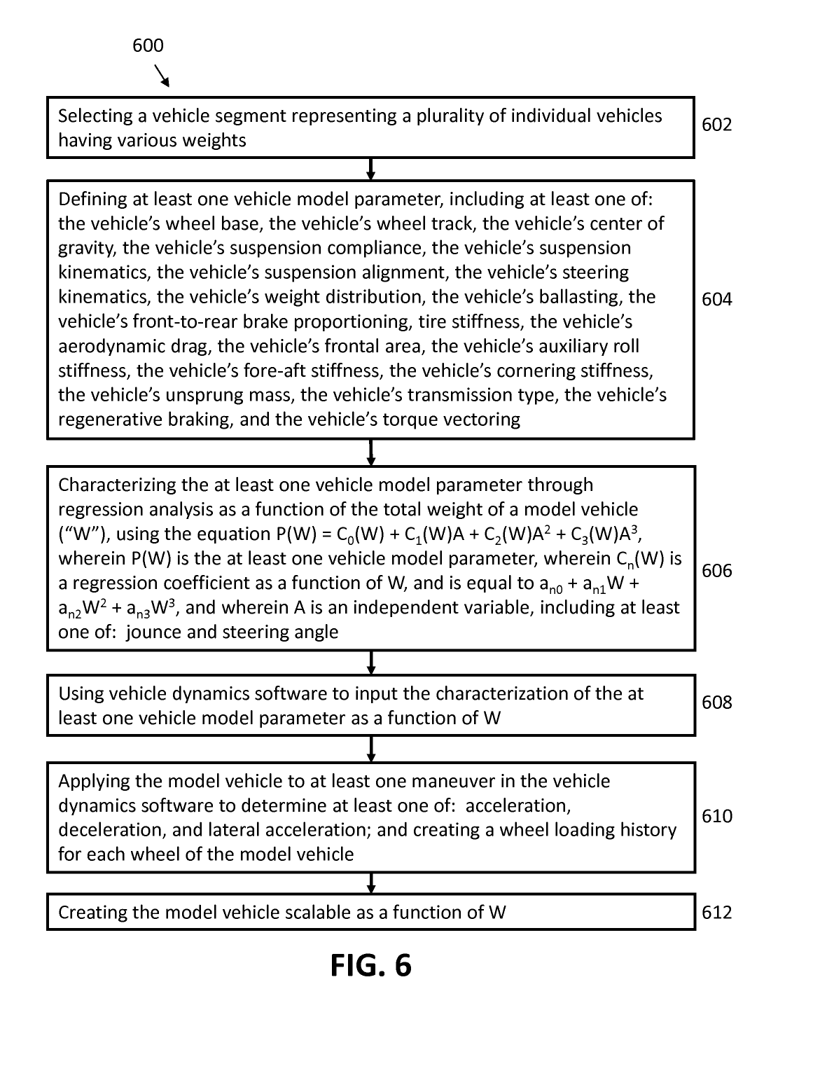

FIG. 6 illustrates an example method 600 for creating a SVM for indoor tire testing. The method comprises selecting a vehicle segment representing a plurality of individual vehicles having various weights (step 602). The method may comprise defining at least one vehicle model parameter, including at least one of: the vehicle's wheel base, the vehicle's wheel track, the vehicle's center of gravity, the vehicle's suspension compliance, the vehicle's suspension kinematics, the vehicle's suspension alignment, the vehicle's steering kinematics, the vehicle's weight distribution, the vehicle's ballasting, the vehicle's front-to-rear brake proportioning, tire stiffness, the vehicle's aerodynamic drag, the vehicle's frontal area, the vehicle's auxiliary roll stiffness, the vehicle's fore-aft stiffness, the vehicle's cornering stiffness, the vehicle's unsprung mass, the vehicle's transmission type, the vehicle's regenerative braking, and the vehicle's torque vectoring (step 604). The method may comprise characterizing the at least one vehicle model parameter through regression analysis as a function of the total weight of a SVM (“W”), using the equation P(W) C₀(W)+C₁(W)A+C₂(W)A²+C₃(W)A³, wherein P(W) is the at least one vehicle model parameter, wherein Cₙ(W) is a regression coefficient as a function of W, and is equal to aₙ₀+aₙ₁W+aₙ₂W²+aₙ₃W³, and wherein A is an independent variable, including at least one of: jounce and steering angle (step 606). The method may comprise using vehicle dynamics software to input the characterization of the at least one vehicle model parameter as a function of W (step 608). The method may comprise applying the SVM to at least one maneuver in the vehicle dynamics software to determine at least one of: acceleration, deceleration, and lateral acceleration; and creating a wheel loading history for each wheel of the SVM (step 610). The method may comprise creating the SVM scalable as a function of W (step 612).

One application of a SVM for indoor wear testing would be for the National Highway Traffic Safety Administration's Uniform Tire Quality Grading (“UTQG”) standard for relative grading of tires for tread wear. During the tire development process for a new line or model of trade tires, it is desirable to quickly and accurately evaluate a number of different prototype tire designs as well as different sizes on an indoor wear test machine to predict the UTQG tread wear grade. For this purpose a SVM is needed that is representative of pick-up trucks with equal front and rear ballasting at nominal alignment. Tires subjected to the UTQG testing may be placed in an indoor testing apparatus, which includes a wear test drum. The wear test drum provides a rotating surface that engages the tire to simulate a road surface. The testing apparatus provides mechanisms for varying the force between the tire and the rotating surface. The velocity of the rotating surface may also be varied.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in tire manufacturing, which in one embodiment is ±0.25 inches. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A method for creating a scalable vehicle model for indoor tire testing, comprising:
selecting a vehicle segment representing a plurality of individual vehicles having various weights;
defining at least one vehicle model parameter, including at least one of: the vehicle's wheel base, the vehicle's wheel track, the vehicle's center of gravity, the vehicle's suspension compliance, the vehicle's suspension kinematics, the vehicle's suspension alignment, the vehicle's steering kinematics, the vehicle's weight distribution, the vehicle's ballasting, the vehicle's front-to-rear brake proportioning, a tire stiffness, the vehicle's aerodynamic drag, the vehicle's frontal area, the vehicle's auxiliary roll stiffness, the vehicle's fore-aft stiffness, the vehicle's cornering stiffness, the vehicle's and unsprung mass; and
characterizing the at least one vehicle model parameter through regression analysis as a function of the total weight of a scalable vehicle model (“W”), using the equation P(W)=C₀(W)+C₁(W)A+C₂(W)A²+C₃(W)A³,
wherein P(W) is the at least one vehicle model parameter,
wherein Cₙ(W) is a regression coefficient as a function of W, and
wherein A is an independent variable, including at least one of: jounce and steering angle.

2. The method of claim 1, wherein Cₙ(W) is equal to aₙ₀+aₙ₁W+aₙ₂W²+aₙ₃W³.

3. The method of claim 1, further comprising using vehicle dynamics software to input the characterization of the at least one scalable vehicle model parameter as a function of W.

4. The method of claim 3, wherein the vehicle dynamics software comprises at least one of CarSim and any other vehicle dynamics software.

5. The method of claim 3, further comprising applying the scalable vehicle model to at least one maneuver in the vehicle dynamics software to determine at least one of: longtitudinal acceleration and deceleration, lateral acceleration, and a tire loading history for each tire of the scalable vehicle model.

6. The method of claim 3, further comprising creating the scalable vehicle model scalable as a function of W.

7. The method of claim 3, further comprising creating at least one formula for a tire force and inclination angle per a tire position on the scalable vehicle model, wherein the tire force and inclination angle are a function of the accelerations of the scalable vehicle model.

8. The method of claim 7, wherein creating at least one formula comprises at least one of: regression curve fit of a tire load as a function of the scalable vehicle model's acceleration, velocity, and path curvature; and regression curve fit of a tire inclination angle as a function of the scalable vehicle model's acceleration, velocity, and path curvature.

9. The method of claim 7, further comprising using the at least one formula to at least one of: drive an indoor tire test machine and provide information for a finite element analysis.

10. A method for creating a scalable vehicle model for indoor tire testing, comprising:
selecting a vehicle segment representing a plurality of individual vehicles having various weights;
defining at least one vehicle model parameter, including at least one of: the vehicle's wheel base, the vehicle's wheel track, the vehicle's center of gravity, the vehicle's suspension compliance, the vehicle's suspension kinematics, the vehicle's suspension alignment, the vehicle's steering kinematics, the vehicle's weight distribution, the vehicle's ballasting, the vehicle's front-to-rear brake proportioning, a tire stiffness, the vehicle's aerodynamic drag, the vehicle's frontal area, the vehicle's auxiliary roll stiffness, the vehicle's fore-aft stiffness, the vehicle's cornering stiffness, and the vehicle's unsprung mass;
characterizing the at least one vehicle model parameter through regression analysis as a function of the total weight of a scalable vehicle model (“W”), using the equation P(W)=C₀(W)+C₁(W)A+C₂(W)A²+C₃(W)A³,
wherein P(W) is the at least one vehicle model parameter,
wherein Cₙ(W) is a regression coefficient as a function of W, and is equal to aₙ₀+aₙ₁W+aₙ₂W²+aₙ₃ W³,
wherein A is an independent variable, including at least one of: jounce and steering angle; and
using vehicle dynamics software to input the characterization of the at least one vehicle model parameter as a function of W.

11. The method of claim 10, wherein the vehicle dynamics software comprises at least one of CarSim and any other vehicle dynamics software.

12. The method of claim 10, further comprising applying the scalable vehicle model to at least one maneuver in the vehicle dynamics software to determine at least one of: acceleration, deceleration, and lateral acceleration; and creating a wheel loading history for each wheel of the scalable vehicle model.

13. The method of claim 10, further comprising creating the scalable vehicle model scalable as a function of W.

14. The method of claim 10, further comprising creating at least one formula for a tire force and inclination angle per a tire position on the scalable vehicle model, wherein the tire force and inclination angle are a function of a center of gravity acceleration and velocity of the scalable vehicle model.

15. The method of claim 14, wherein creating at least one formula comprises at least one of: regression curve fit of a tire load as a function of the scalable vehicle model's acceleration, velocity, and path curvature; and regression curve fit of a tire inclination angle as a function of the scalable vehicle model's acceleration, velocity, and path curvature.

16. The method of claim 14, further comprising using the at least one formula to at least one of: drive an indoor tire test machine and input information into a finite element analysis.

17. A method for creating a scalable vehicle model for indoor tire testing, comprising:
selecting a vehicle segment representing a plurality of individual vehicles having various weights;
defining at least one vehicle model parameter, including at least one of: the vehicle's wheel base, the vehicle's wheel track, the vehicle's center of gravity, the vehicle's suspension compliance, the vehicle's suspension kinematics, the vehicle's suspension alignment, the vehicle's steering kinematics, the vehicle's weight distribution, the vehicle's ballasting, the vehicle's front-to-rear brake proportioning, a tire stiffness, the vehicle's aerodynamic drag, the vehicle's frontal area, the vehicle's auxiliary roll stiffness, the vehicle's fore-aft stiffness, the vehicle's cornering stiffness, the vehicle's unsprung mass;
characterizing the at least one vehicle model parameter through regression analysis as a function of the total weight of a scalable vehicle model (“W”), using the equation P(W)=C₀(W)+C₁(W)A+C₂(W)A²+C₃(W)A³,
wherein P(W) is the at least one vehicle model parameter,
wherein Cₙ(W) is a regression coefficient as a function of W, and is equal to aₙ₀+aₙ₁W+aₙ₂W²+aₙ₃W³,
wherein A is an independent variable, including at least one of: jounce and steering angle;
using vehicle dynamics software to input the characterization of the at least one vehicle model parameter as a function of W;
applying the scalable vehicle model to at least one maneuver in the vehicle dynamics software to determine at least one of: acceleration, deceleration, and lateral acceleration; and creating a wheel loading history for each wheel of the scalable vehicle model; and
creating the scalable vehicle model scalable as a function of W.

18. The method of claim 17, further comprising creating at least one formula for a tire force and inclination angle per a tire position on the scalable vehicle model, wherein the tire force and inclination angle are a function of a center of gravity acceleration and velocity of the scalable vehicle model.

19. The method of claim 18, wherein creating at least one formula comprises at least one of: regression curve fit of a tire load as a function of the scalable vehicle model's acceleration, velocity, and path curvature; and regression curve fit of a tire inclination angle as a function of the scalable vehicle model's acceleration, velocity, and path curvature.

20. The method of claim 18, further comprising using the at least one formula to at least one of: drive an indoor tire test machine and input information into a finite element analysis.
